(19) United States
(12) Patent Application Publication
(10) Pub. No.: US 2009/0001054 A1
(43) Pub. Date: Jan. 1, 2009

(54) BONDING METHOD AND BONDING APPARATUS

(75) Inventors: Toru Mizuno, Tokyo (JP); Tatsuya Wagou, Tokyo (JP); Hidetoshi Suzuki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK CORPORATION, Tokyo (JP)

(21) Appl. No.: 12/143,267

(22) Filed: Jun. 20, 2008

(30) Foreign Application Priority Data
Jun. 26, 2007 (JP) 2007-167258
Jan. 11, 2008 (JP) 2008-004358

(51) Int. Cl. B23K 11/00; B23K 11/24

(52) U.S. Cl. 219/78.13; 219/117.1; 219/78.01; 219/79

(57) ABSTRACT

The present invention relates to a bonding method or an apparatus for projecting a conductive element from a nozzle onto an object to be bonded and electrically bonding the object to be bonded and the conductive element. The method of invention comprises the steps of: preparing the conductive element having an outer diameter with a curvature radius larger than a curvature radius of a portion of an opening of the nozzle which is in contact with the conductive element; pressurizing and attaching the conductive element to the opening of the nozzle; and supplying a compressed gas into an inner space of the nozzle and projecting the conductive element in a solid phase state onto the object to be bonded.

### BACKGROUND OF THE INVENTION

1. Field of the Invention

The present invention relates to a bonding method and a bonding apparatus for electrically bonding a conductive element and an object to be bonded.

2. Related Background Art

In a process for manufacturing magnetic heads, an electrode of a magnetic head slider and an electrode of a flexure are bonded by soldering by using a solder ball. More specifically, electrical bonding of the electrodes is performed by disposing the both electrodes with an angle of 90 degrees therebetween, disposing a solder ball between the electrodes and melting the solder ball by heat radiation or the like. Conventional solder ball soldering apparatuses will be described below with reference to the drawings.

FIG. 11 illustrates a first conventional soldering apparatus described in Japanese Patent Application Laid-Open No. 2002-25025. In the drawing, reference numeral 709 denotes a substantially rectangular solid slider, and reference numeral 711 denotes a flexure. A slider electrode 713 is provided at one end of the slider 709. Also, the slider 709 is attached to the thin-plate flexure 711, and a flexure electrode 715 of the flexure 711 extends so as to be at about 90 degrees with respect to the slider electrode 713.

First, a suction nozzle 700 sucks and holds a solder ball 707 in a suction opening 703 by a suction force from an unshown suction source, and carries the solder ball 707 to a position in contact with the slider electrode 713 and the flexure electrode 715. The suction force of the suction nozzle 700 is released to leave the solder ball 707 in the position in contact with the both electrodes, and the suction nozzle 700 moves away from the position. A laser beam is emitted to the solder ball 707 via an inner space 705 of an optical apparatus 710 to melt the solder ball 707 in the state in which the solder ball 707 is partially inserted in a laser output opening 712 of the optical apparatus 710. The solder ball 707 is fixed between the slider electrode 713 and the flexure electrode 715 to electrically bond the both electrodes.

Recently, as magnetic heads are reduced in size, objects to be bonded, such as the slider electrode and the flexure electrode described above, are also becoming increasingly smaller. It is necessary for the above soldering apparatus to stably and reliably move the suction opening 703 of the suction nozzle 700 or the laser output opening 712 of the optical apparatus 710 close to the electrodes 715 and 713 with the solder ball 707 being sucked. However, as the electrodes are becoming smaller, it is becoming difficult to carry and melt the solder ball 707 using the suction nozzle 700 and the optical apparatus 710 without contacting other electronic components. Also, there is a possibility that the residue of the molten solder ball 707 adheres to the laser output opening 712. Accordingly, another type of soldering apparatus has been proposed. The configuration of a second conventional soldering apparatus will be described below.

FIG. 12 is a partial cross-sectional view of the second conventional soldering apparatus disclosed in Japanese Patent Application Laid-Open No. 2006-305625. In a soldering apparatus 800, a solid solder ball 807 is projected and then is melted. The molten solder ball 807 adheres between a slider electrode 813 and a flexure electrode 815 to thereby perform soldering.

The soldering apparatus 800 comprises a nozzle assembly 801 constituted by a nozzle 802 for projecting the solder ball 807 and a nozzle main body 813 for holding the nozzle 802, a reservoir 815 for storing the solder ball 807, a laser apparatus 817 for melting the solder ball 807, a shutter 823 for opening and closing an opening 803 of the nozzle 802, a drive unit 825 for opening and closing the shutter 823, and a control unit 835 for synchronizing the actions of the laser apparatus 817 and the drive unit 825.

The curvature radius of the inner diameter in the vicinity of the opening 803 of an inner space 805 disposed inside the nozzle 802 is set to be larger than the curvature radius of the outer diameter of the solder ball 807. Therefore, the solid solder ball 807 introduced into the inner space 805 of the nozzle 802 is held by the shutter 823 in the inner space 805 in the vicinity of the opening 803.

Also, a laser beam from the laser apparatus 817 is introduced into the inner space 805 of the nozzle 802 through a laser introduction path 819 of the nozzle main body 813. The control unit 835 drives the laser apparatus 817 to melt the solder ball 807a such that the solder ball 807a is melted after the shutter 823 is opened and the solder ball 807a passes through the opening 803.

In the soldering apparatus of Japanese Patent Application Laid-Open No. 2002-25025 described above, the solder ball 707 in the suction opening 703 of the suction nozzle 700 is placed between and adjacent to the flexure electrode 715 and the slider electrode 713. After that, the solder ball 707 is put into the laser output opening 712 of the optical apparatus 710, and a laser beam is emitted to melt the solder ball 707. Thus, there is a possibility that the residue of the solder element adheres to the periphery of the laser output opening 712.

The soldering apparatus 800 of Japanese Patent Application Laid-Open No. 2006-305625 described above is configured to melt the solder ball 807a and bond the slider electrode 813 and the flexure electrode 815 after the shutter 823 opens the opening 803 to project the solder ball 807. There is no possibility that a portion or all of the molten solder ball 807a adheres to an inner wall surface of the inner space 805 and an outer wall surface around the opening 803.

With the arrangement interval and the dimensions of electronic components which are presently used, there is no trouble caused by landing accuracy of the bonding element. However, if the bonding element such as the solder ball is further reduced in size along with further miniaturization of electronic components in the future, the influence on the bonding element (for example, a force component in the right direction in the drawing) is expected to become noticeable when the shutter 823 moves to open the opening 803, so that deviation in the projecting direction is caused.

Also, in the soldering apparatus of Japanese Patent Application Laid-Open No. 2006-305625, it is necessary to synchronize the action timing of the shutter 823 and the action timing of the laser apparatus 817, and the configuration tends to be complicated. Thus, it is difficult to further reduce the size of and simplify a bonding apparatus.

### SUMMARY OF THE INVENTION

In light of the above circumstances, an object of the present invention is to provide a bonding method and a bonding apparatus, which has a small and simple configuration, in which the residue of a bonding element does not adhere to a nozzle opening and the vicinity thereof, and which allows to improve landing accuracy.

In order to achieve the above object, a first aspect of a bonding method of the present invention is a bonding method for projecting a conductive element from a nozzle onto an object to be bonded and electrically bonding the object to be bonded and the conductive element, comprising the steps of: preparing the conductive element having an outer diameter with a curvature radius larger than a curvature radius of a portion of an opening of the nozzle which is in contact with the conductive element; pressurizing and attaching the conductive element to the opening of the nozzle; and supplying a compressed gas into an inner space of the nozzle and projecting the conductive element in a solid phase state onto the object to be bonded.

According to a second aspect of the bonding method of the present invention, heat radiation is emitted to the conductive element pressurized and attached to the opening when a pressure inside the inner space is at a predetermined value.

According to a third aspect of the bonding method of the present invention, the conductive element is pressurized and attached to the opening by pressing the nozzle against the conductive element.

According to a fourth aspect of the bonding method of the present invention, the conductive element is pressurized and attached to the opening by a suction force imparted to the opening via the inner space.

According to a fifth aspect of the bonding method of the present invention, the conductive element is pressurized and attached to the opening by pushing the conductive element in abutment with the opening by the suction force into the opening by a pressure and fit unit.

According to a sixth aspect of the bonding method of the present invention, after the conductive element is projected, the heat radiation continues to be emitted to the conductive element.

Also, in order to achieve the above object, a first aspect of a bonding apparatus of the present invention is a bonding apparatus for disposing a conductive element on an object to be bonded and electrically bonding the object to be bonded and the conductive element, comprising: a nozzle having an opening with a curvature radius smaller than a curvature radius of an outer diameter of the conductive element, and an inner space in communication with an outside via the opening; gas supply means for supplying a compressed gas into the inner space; pressure and fit means for pressurizing and fitting the conductive element into the opening of the nozzle and pressurizing and attaching the conductive element to the opening; and a control unit for controlling the gas supply means such that, with the conductive element being pressurized and attached to the opening, the compressed gas is supplied into the inner space and the conductive element is projected in a solid phase state.

According to a second aspect of the bonding apparatus of the present invention, the bonding apparatus further comprises heat radiation emit means for emitting heat radiation to the conductive element pressurized and attached to the opening, wherein the control unit controls the heat radiation emit means such that heat radiation is emitted to the conductive element when the inner space has the predetermined pressure.

According to a third aspect of the bonding apparatus of the present invention, the pressure and fit means pressurizes and fits the conductive element into the opening such that the conductive element is pressurized and attached with a portion of the conductive element having a larger dimension than an inner diameter of the opening being located outside of the nozzle.

According to a fourth aspect of the bonding apparatus of the present invention, the pressure and fit means has drive means for moving the opening and the conductive element in directions toward and away from each other.

According to a fifth aspect of the bonding apparatus of the present invention, the pressure and fit means has suction means for imparting a suction force to the opening via the inner space and assisting the pressure-attachment of the conductive element to the opening.

The term outside of the nozzle in the present specification is defined as an area other than the inner space by regarding the inner space which is defined by a member forming the nozzle as the inside. Accordingly, the opening of the nozzle, an opening area defined by the opening, and an outer space of the nozzle are regarded as outside of the nozzle.

As the compressed gas used in the gas supply means, an inert gas (nitrogen) or a gas (hydrogen or the like) capable of reducing the conductive element can be used.

Also, in the present specification, the term conductive element means a member composed of a metal material such as solder and gold, or alloy, which can electrically connect members to each other as the object to be bonded.

Moreover, in the present specification, the term object to be bonded means a conductor electrode and the like for electrical connection between a substrate (printed circuit board (PCB), flexible printed circuit (FPC)) and an electronic component, and includes a conductive element for directly performing electrical bonding between a substrate and an electronic component by the conductive element, or a member on which a bump for performing the electrical bonding in a subsequent process is formed.

Since the present invention is configured such that the conductive element is projected in a solid phase state, the residue of the conductive element does not adhere to the nozzle opening and the vicinity thereof.

Furthermore, the conductive element is pressurized and attached to the opening, and is projected by supplying a compressed air such that the compressed air exceeds a frictional force between the opening and the conductive element. Accordingly, it is not necessary to provide another member for holding the conductive element in the nozzle, and it is not necessary to synchronize another element and the heat radiation emit means. Therefore, it is possible to reduce the size of and simplify the configuration of the bonding apparatus.

Since the shutter is not required, the influence of the shutter on the conductive element can be eliminated, and there is no possibility that a force in a direction different from the projecting direction is imparted. Accordingly, it is possible to improve the landing position accuracy of the bonding element.

### BRIEF DESCRIPTION OF THE DRAWINGS

FIGS. 1A, 1B, 1C, and 1D are partial cross-sectional views in respective soldering steps of a soldering apparatus according to an embodiment 1, FIG. 1E is a cross-sectional view illustrating the relationship between a nozzle and a solder ball in the embodiment 1, and FIGS. 1F and 1G are cross-sectional views respectively illustrating the state of a force acting on a pressurized and attached solder ball;

FIG. 2 is a flowchart of a soldering process;

FIG. 3 is a cross-sectional view of a nozzle according to a modification;

FIG. 4 is a partial cross-sectional view of a soldering apparatus according to an embodiment 2;

FIG. 5 is a partial cross-sectional view of a soldering apparatus according to a modification 2;

FIG. 6A is a partial cross-sectional view of a soldering apparatus according to an embodiment 3, and FIG. 6B is a cross-sectional view along a line 6B-6B in FIG. 6A;

FIG. 7 is a side schematic view of a soldering apparatus 1;

FIG. 8 is a partial cross-sectional view of a soldering apparatus in which a laser beam emit unit is fixed to a nozzle;

FIG. 9 illustrates the state in which a solder ball is projected onto an object to be bonded which is a planar conductor and a solder bump is formed thereon by using a soldering apparatus 101 in FIG. 1;

FIG. 10 is a flowchart of a soldering process as another example of the embodiment 1;

FIG. 11 is a partial cross-sectional view of a first conventional soldering apparatus; and

FIG. 12 is a partial cross-sectional view of a second conventional soldering apparatus.

### DESCRIPTION OF THE PREFERRED EMBODIMENTS

Embodiments in which a bonding apparatus for bonding objects to be bonded according to the present invention is applied to a soldering apparatus will be described below with reference to the drawings.

### Embodiment 1

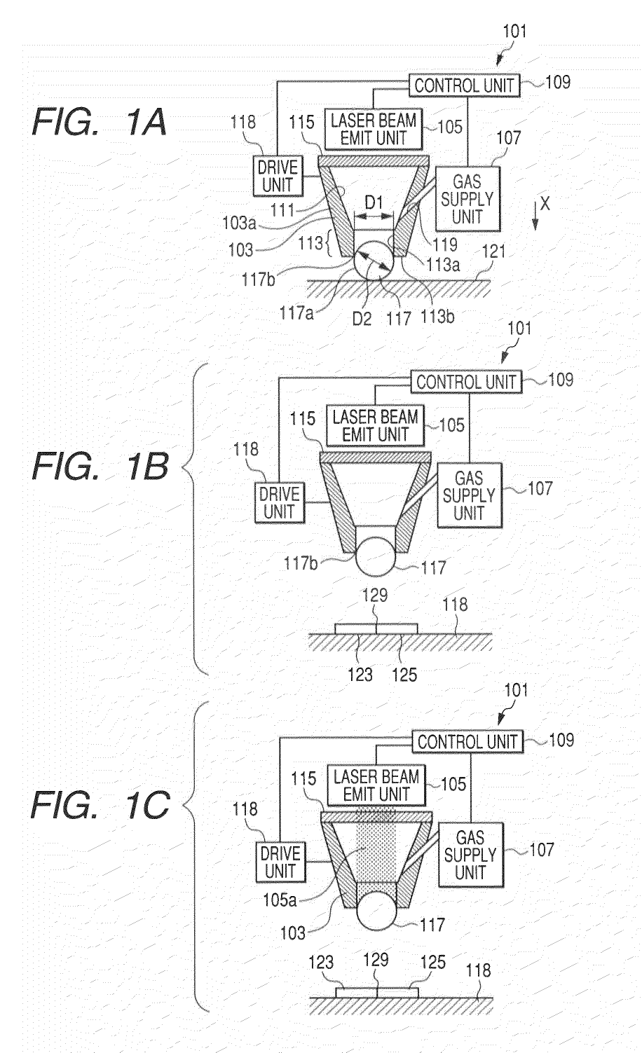

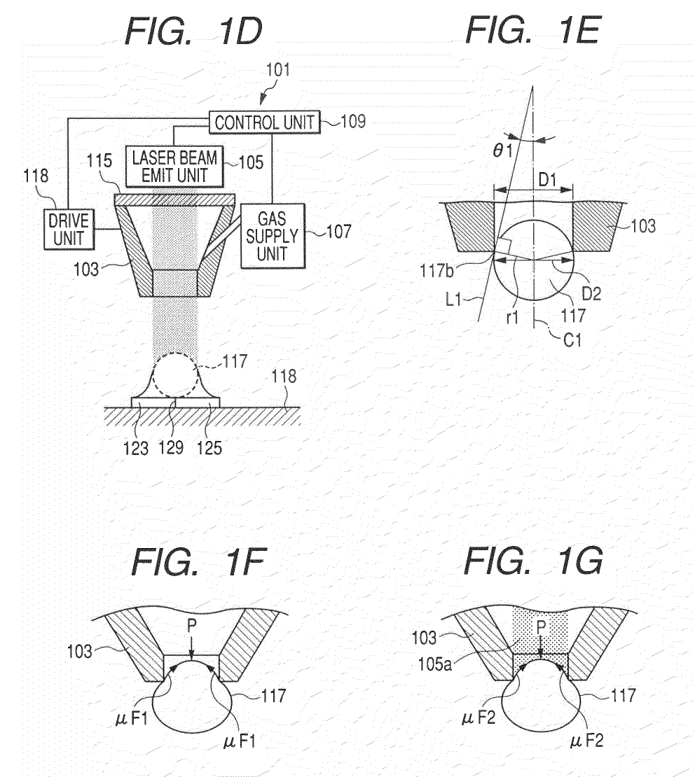

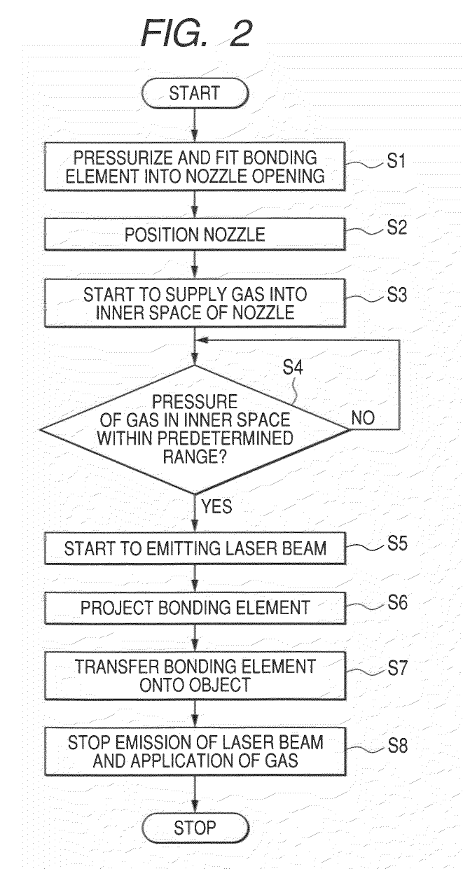

FIGS. 1A, 1B, 1C, and 1D are partial cross-sectional views in respective soldering steps of a soldering apparatus according to an embodiment 1. FIG. 1E is a cross-sectional view illustrating the relationship between a nozzle and a solder ball in the embodiment 1. FIGS. 1F and 1G are cross-sectional views respectively illustrating the state of a force acting on a solder ball pressurized and attached to an opening. FIG. 2 is a flowchart of a soldering process.

As shown in FIG. 1A, a soldering apparatus 101 mainly comprises a nozzle 103 for projecting a solder ball 117, a laser beam emit unit 105, a gas supply unit 107, a drive unit 118 (namely, pressure and fit means) for moving the nozzle 103 and pressurizing and fitting the solder ball 117 thereinto, and a control unit 109. The nozzle 103 comprises an inner space 111 therein, through which a laser beam described below passes and into which a compressed gas is supplied, and is a cylindrical member which opens at both ends thereof in the longitudinal direction. One end of the nozzle 103 in the longitudinal direction is closed by a top plate 115 formed of glass or the like through which only a laser beam can be transmitted, and the other end constitutes an opening 113 to which the solder ball 117 is pressurized and attached. The opening 113 has a predetermined length in the longitudinal direction of the nozzle 103. Also, the opening 113 connects to the inner space 111, and has an inner peripheral surface 113a with a uniform inner diameter (or a curvature radius). The inner diameter is at least set to be smaller than the outer diameter (or the curvature radius) of the solder ball 117.

Furthermore, the nozzle 103 is provided with the drive unit 118 for moving the nozzle 103 toward and away from the solder ball 117. Accordingly, after the opening 113 of the nozzle 103 is moved closer to the solder ball 117 and the opening 113 is brought into abutment with the solder ball 117, the opening 113 is further pressed against the solder ball 117 to pressurize and attach the solder ball 117 to a top end portion 113b of the opening 113. The inner space 111 is in a substantially sealed state when the solder ball 117 is being pressurized and attached to the opening 113.

Also, a gas introduction path 119 for bringing the outside of the nozzle 103 and the inner space 111 into communication with each other is provided in a peripheral wall 103a of the nozzle 103. The gas introduction path 119 is coupled to the gas supply unit 107 which is a gas source, and a compressed gas from the gas supply unit 107 is supplied into the inner space 111.

Furthermore, the laser beam emit unit 105 which is heat emit means is disposed in the vicinity of the top plate 115 of the nozzle 103. A well known laser beam emit unit is used as the laser beam emit unit 105. The optical axis of a laser beam emitted from the laser beam emit unit 105 is aligned in a straight line with the central axis of the inner space 111 and the opening 113. Accordingly, the laser beam is transmitted through the top plate 115, and enters the inner space 111 of the nozzle 103. Then, the laser beam passes through the inner space 111 and travels to the outside of the nozzle 103 through the opening 113. As described above, the inner space 111 also functions as a laser introduction path for guiding the laser beam to the solder ball 117.

After lowering the nozzle 103 to bring the nozzle 103 into abutment with the solder ball 117 which is placed on a reservoir 121, the opening 113 of the nozzle 103 is further pressed against the solder ball 117 with a predetermined force, and the solder ball 117 is thereby pressurized and fitted into the opening 113.

A diameter portion 117a of the solder ball 117, which is the maximum dimension portion of a cross section along a horizontal plane extending in the horizontal (lateral) direction in the drawing, is located in a side closer to the reservoir 121 than an abutment portion 117b of the solder ball 117 which is in abutment with the top end portion 113b in the projecting direction x. That is, the solder ball 117 is pressurized and attached to the nozzle 103 in the state in which the diameter portion 117a is located outward from a contact portion of the opening 113 of the nozzle 103 and the solder ball 117. In other words, the solder ball 117 is located outside of the nozzle 103 (the opening or an outer space), and does not exist inside of the nozzle 103.

The term maximum dimension portion means the maximum length of a line segment connecting any two points on the outer periphery which defines the cross section of the solder ball by a plane extending perpendicular to the projecting direction (the vertical direction in the present embodiment).

Also, the laser beam emit unit 105, the gas supply unit 107, and the drive unit 118 are coupled to the control unit 109, and are actuated by the control unit 109. When the laser beam emit unit 105 receives a drive signal from the control unit 109, a laser beam is emitted from the laser beam emit unit 105. Similarly, when the gas supply unit 107 receives a drive signal from the control unit 109, a compressed gas is supplied into the inner space 111. When the solder ball 117 is softened by the laser beam from the laser beam emit unit 105, the pressure-attachment of the solder ball 117 is released and the solder ball 117 is projected since the inner pressure of the inner space 111 is increased by the compressed gas from the gas supply unit 107.

The process steps of a soldering method using the soldering apparatus 101 having the above configuration will be described with reference to FIGS. 1A, 1B, 1C, 1D and FIG. 2.

As shown in FIG. 1A, the drive unit 118 moves the nozzle 103 to the reservoir 121, and pressurizes and fits the solder ball 117 into the opening 113 to pressurize and attach the solder ball 117 to the top end portion 113b (the step S1). In the present embodiment, the solder ball 117 is pressurized and fitted into the opening 113 by lowering the nozzle 103 with respect to the reservoir 121 on which the solder ball 117 is placed.

The state of the opening 113 of the nozzle 103 at this time is shown in FIG. 1F. The pressurized and attached solder ball 117 is deformed, and an internal stress is thereby generated. The solder ball 117 is held by the opening 113 by a frictional force μF1 arising from the internal stress. In the state in which the solder ball 117 is pressurized and fitted as shown in FIG. 1A, the diameter portion 117a of the solder ball 117 is located further from the inner space 111 than the top end portion 113b in the projecting direction x.

Next, as shown in FIG. 1B, positioning of the nozzle 103 with respect to electrodes or conductive patterns 123 and 125 (for details, see a contact portion 129 in FIG. 1D) which are the objects to be bonded placed on a work bench 118 is performed (the step S2). Of course, the work bench 118 may be moved with the nozzle 103 being fixed.

Subsequently, a compressed gas is supplied from the gas supply unit 107 into the inner space 111 (the step S3). It is determined by the control unit 109 whether the pressure in the inner space 111 reaches a predetermined value (the step S4). When the control unit 109 determines that the pressure in the inner space 111 reaches a predetermined value, a laser beam 105a is emitted from the laser beam emit unit 105 through the inner space 111 to the solder ball 117 (FIG. 1C, the step S5). Whether the pressure in the inner space 111 reaches a predetermined pressure or not can be determined, for example, by measuring in advance a predetermined time until the pressure reaches a predetermined pressure after the gas supply, and determining whether the predetermined time has elapsed after the gas supply by the control unit.

When the laser beam 105a is emitted to heat a portion of the solder ball 117 which faces the inner space 111, the elastic coefficient of the solder ball 117 is lowered, resulting in that the internal stress is reduced. At this time, an urging force P of the compressed gas filled inside the inner space 111 exceeds a frictional force (holding force) μF2 arising from the internal stress of the solder ball, and the pressure-attachment of the solder ball 117 to the top end portion 113b of the opening 113 is thereby released. Accordingly, the substantially spherical solder ball 117 is projected in a solid phase state (FIGS. 1D and 1G, the step S6). Since the solder ball 117 to which the laser beam 105a is emitted is heated and the elastic coefficient thereof is lowered, the internal stress is reduced. As a result, the frictional force μF2 arising from the internal stress becomes relatively smaller than the friction force μF1 generated in the solder ball 117 which is not heated.

The projected solder ball 117 lands on the contact portion 129 of the objects to be bonded 123 and 125 on the work bench 118 (FIG. 1D, the step S7). The laser beam emit unit 105 continues to emit the laser beam 105a until the solder ball 117 is melted.

After the solder ball is melted on the landing position (the contact position 129), the control unit 109 sends a signal to the laser beam emit unit 105 and the gas supply means 107 to stop the operations thereof (the step S8).

As described above, in a bonding apparatus 1 in the present embodiment, after pressurizing and attaching the solid solder ball 117 to the opening 113 of the nozzle 103, the compressed gas is supplied into the inner space, and when the inner space has a predetermined pressure value, the laser beam 105a is emitted from the laser beam emit unit 105, and the pressure-attachment of the solder ball 117 is released in a solid phase state by the compressed gas. Because of the configuration, the configuration of the soldering apparatus is simplified and the soldering apparatus is more easily controlled.

The inventors have keenly studied, and as a result, found out that, when an inner diameter D1 of the opening 113 of the nozzle 103 is 0.095 mm and a diameter D2 of the solder ball 117 is 0.11 mm, desired landing accuracy can be obtained by setting a D1/D2 ratio to 0.78 to 0.95, and more preferably, to 0.82 to 0.91. When expressed as a contact angle θ1 of the solder ball 117 and the opening 113, it is preferable to set the contact angle θ1 to 18 to 38 degrees, and more preferably, to 25 to 35 degrees. The contact angle is an angle formed between a central line C1 (a vertical line passing through the center of the solder ball) of the opening 113 and a perpendicular line L1 with respect to a radius r1 which connects the center of the solder ball 117 and the abutment portion 117b in contact with the opening 113.

### (Modification 1)

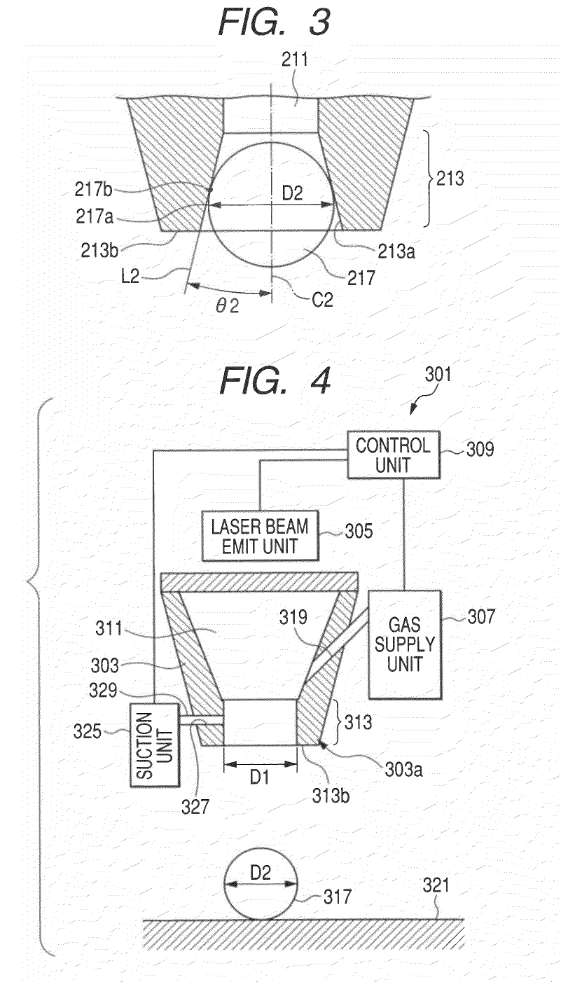

A modification of the embodiment 1 will be described. FIG. 3 is a cross-sectional view of a nozzle according to the modification 1. An opening 213 of the present modification has a shape widening toward the top unlike the embodiment 1. That is, the opening 213 has such a configuration that the inner diameter increases gradually from an inner space 211 side toward a top end portion 213b.

In the state in which a solder ball 217 is pressurized and attached to the opening 213, the solder ball 217 is pressurized and attached such that a diameter portion 217a which is the maximum dimension portion of the solder ball 217 is located closer to the top end portion 213b side than an abutment portion 217b of the solder ball 217. With the configuration as described above, even if there are variations in the dimensions of the solder balls to be used, it is possible to locate the maximum dimension portion 217a closer to the top end portion 213b side of the nozzle than the abutment portion 217b. Other configurations and operations are the same as those of the embodiment 1, and therefore, the descriptions thereof are omitted.

The inventors have keenly studied and as a result, found out that, when a diameter D2 of the solder ball 217 is 0.11 mm, desired projecting accuracy can be obtained by setting an inclination angle of an inner peripheral surface 213a (a line L2) of the opening 213 against the vertical direction (a line C2), namely, a contact angle θ2 of the solder ball 217 and the opening 213, to 3 to 35 degrees, and more preferably, to 5 to 30 degrees.

### Embodiment 2

An embodiment 2 is a soldering apparatus using suction means as pressure and attach means for pressurizing and attaching the solder ball to the opening, and will be described below with reference to FIG. 4. FIG. 4 is a partial cross-sectional view of the soldering apparatus according to the embodiment 2.

A soldering apparatus 301 mainly comprises a nozzle 303, a laser beam emit unit 305, a gas supply unit 307, a control unit 309, and a suction unit 325 which constitutes the suction means. The laser beam emit unit 305, the gas supply unit 307 and a gas introduction path 319 have the same configurations and operations as those in the embodiment 1, and therefore, the descriptions thereof are omitted. Also, for simplicity of the drawing, a drive unit having the same configuration and operation as that in the embodiment 1 for moving the nozzle 303 is omitted from the drawing.

The suction means comprises the suction unit 325 which is a well known vacuum pump or the like, a suction hole 327 disposed in a peripheral wall 303a of the nozzle 303 and bringing an inner space 311 and the outside into communication with each other, and a tube 329 for coupling the suction unit 325 and the suction hole 327. The suction hole 327 extends by penetrating the side wall 303a in the vicinity of an opening 313 of the nozzle 303 in the horizontal direction. Thus, a suction force from the suction unit 325 is imparted to the outside of the nozzle 303 via the tube 329, the suction hole 327 and the opening 313.

The position of the suction hole 327 can be changed as needed, and the suction hole 327 may be configured to bring the inner space 311 and the outside into communication with each other. Also, such a configuration that only one of the suction hole 327 or the gas introduction path 319, as a through hole for bringing the outside of the nozzle and the inner space 311 into communication with each other, is provided in the nozzle to use the single through hole as both the suction hole and the gas introduction path and the gas supply unit 307 and the suction unit 325 are connected to the single through hole, may be employed. In other words, as long as the suction force can be imparted to the outside of the nozzle 303 via the opening 313, any change may be made.

In the above configuration, by imparting the suction force of the suction unit 325 to a solder ball 317 through the inner space 311 and the opening 313, the solder ball 317 is sucked and is pressurized and attached to a top end portion 313b of the opening 313 by the suction force.

Also, the suction unit 325 is connected to the control unit 309 and is actuated upon reception of a signal from the control unit 309 like the laser beam emit unit 305 and the gas supply unit 307. The soldering process by the soldering apparatus in the present embodiment differs from the process of the embodiment 1 in the pressurizing and attaching step shown in FIG. 2 (corresponding to the step S1 in FIG. 2). That is, in the step of pressurizing and attaching the solder ball 317 (corresponding to the step S1 in FIG. 2), in order to bring the opening 313 of the nozzle 303 and the solder ball 317 into abutment with each other, the nozzle 303 is not lowered, but the suction unit 325 is actuated to pressurize and attach the solder ball 317 to the opening 313 by the suction force. The suction unit 325 is then stopped to terminate the pressurizing and attaching step. The subsequent steps are the same as those shown in FIG. 2 of the embodiment 1.

Also, the embodiment 1 and the embodiment 2 may be combined. That is, at the same time as, or before or after moving the opening 313 of the nozzle 303 closer to and into abutment with the solder ball 317, the suction unit 325 is actuated to pressurize and attach the solder ball 317 to the opening 313.

In the case of the configuration, by setting the suction timing to be earlier than the timing when the opening 313 and the solder ball 317 abut each other, even if the relative position of the solder ball 317 with respect to the opening 313 is deviated, the solder ball 317 is sucked to the opening 313 and can be reliably brought into abutment with the top end portion 313b. Also, with the solder ball 317 being sucked to the nozzle 303, the solder ball 317 can be pressurized and attached by pressing the nozzle against the solder ball 317 on a work bench 321.

### (Modification 2)

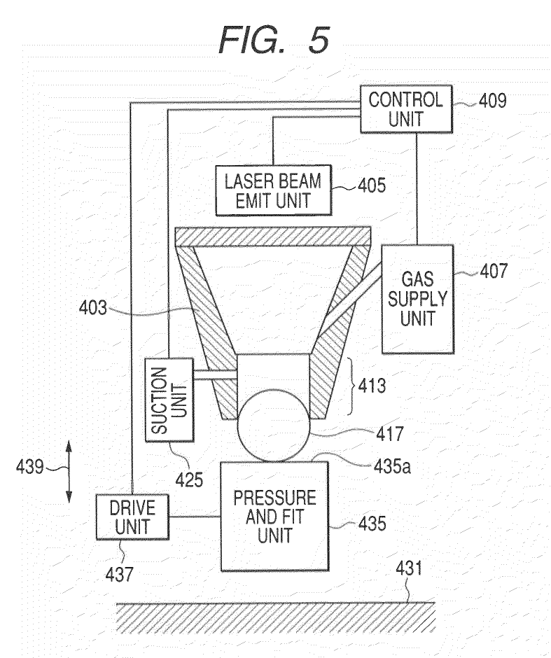

FIG. 5 is a cross-sectional view of a nozzle according to a modification 2. In the embodiment 2, the solder ball 317 is pressurized and attached to the opening 313 of the nozzle 303 by the suction force. In the modification 2, a bonding apparatus may be provided with pressure and fit means, namely, a pressure and fit unit 435 for pushing a solder ball 417 into an opening 413 after the solder ball 417 is sucked and is brought into abutment with the opening 413. The pressure and fit unit 435 is a member having any shape, and has a flat pressure and fit surface 435a which faces the opening 413. Also, the pressure and fit unit 435 is moved toward and away from (moved in the (vertical) direction of an arrow 439) the opening 413 by a drive unit 437. A laser beam emit unit 405, a gas supply unit 407, a control unit 409, a suction unit 425 and the drive unit 437 have the same configurations and operations as the corresponding units described in the embodiment 2, and therefore, the descriptions thereof are omitted here.

For example, after the solder ball 417 is sucked by the suction unit 425, the solder ball 417 is pressed in the direction toward the opening 413 (the arrow 439) by the pressure and fit surface 435a of the pressure and fit unit 435, and the solder ball 417 is thereby pressurized and fitted into the opening 413. After the solder ball 417 is pressurized and attached, the pressure and fit unit 435 is moved away from the opening 413 to terminate the pressure-fitting.

According to the modification, even if the solder ball 417 is not sufficiently pressurized and fitted only by the suction force, the solder ball 417 can be reliably pushed into the opening 413 by the pressure and fit unit 435. The steps after the pressure-fitting are the same as those in the embodiment 1. For simplicity of the drawing, a drive unit having the same configuration and operation as that in the embodiment 1 for moving a nozzle 403 is omitted from the drawing.

### Embodiment 3

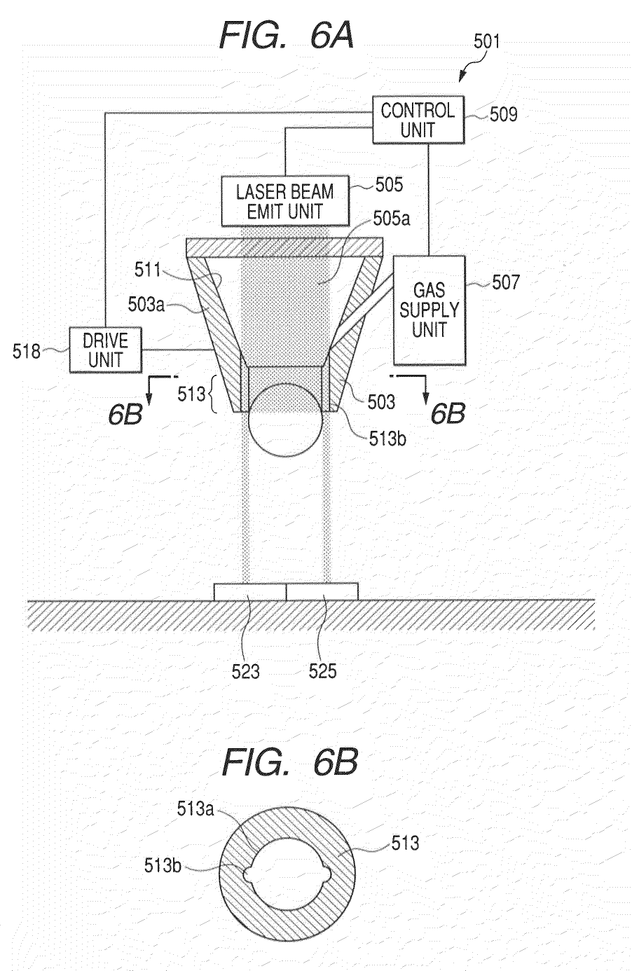

FIG. 6A is a partial cross-sectional view of a soldering apparatus 501 according to an embodiment 3, and FIG. 6B is a cross-sectional view along a line 6B-6B in FIG. 6A. The soldering apparatus 501 of the embodiment 3 differs from the embodiment 1 described above in the opening shape of an opening 513 of a nozzle 503. Other configurations such as a gas supply unit 507, a control unit 509 a drive unit 518 or the like have the same operations as the corresponding configurations therein. Thus, the descriptions of the same configurations and functions are omitted.

As shown in FIG. 6B, the opening 513 is constituted by a circular portion 513a having a predetermined curvature radius and a slit portion 513b traversing the circular portion 513a. The curvature radius of the circular portion 513a is set to be smaller than the curvature radius of a solder ball 517. Also, the slit portion 513b has a substantially semicircular shape with a predetermined curvature radius. In the present embodiment, when the solder ball 517 is pressurized and fitted into the opening 513, a portion of the outer peripheral surface of the solder ball 517 is pressurized and attached to the circular portion 513a, and a gap is formed between the slit portion 513b and the outer peripheral surface of the solder ball 517. In other words, in the state in which the solder ball 517 is pressurized and attached, the circular portion 513a is covered by the solder ball 517 and the slit portion 513b is not covered by the solder ball 517.

The process of performing bonding by the solder ball by using the nozzle 503 having the above configuration is the same as the process of FIG. 2 described in the embodiment 1 except for the gas supply step of supplying a compressed gas (corresponding to the step S3 in FIG. 2) and the step of emitting a laser beam (corresponding to the step S5 in FIG. 2). In the embodiments described above, since the solder ball is pressurized and attached to the opening, an inner space 511 is in a sealed state. However, in the present embodiment, the slit portion 513b is provided. Therefore, when a compressed gas is supplied in the gas supply step (corresponding to the step S3 in FIG. 2), the compressed gas passes through the slit portion 513b and is imparted to objects to be bonded 523 and 525. Accordingly, it is possible to prevent the objects to be bonded 523 and 525 from being oxidized before the solder ball 517 adheres to the objects to be bonded 523 and 525. A soldering failure caused by the oxidization of the objects to be bonded 523 and 525 can be thereby prevented.

Also, in the step of emitting a laser beam (corresponding to the step S5 in FIG. 2), a portion of a laser beam 505a reaches the objects to be bonded 523 and 525 through the slit portion 513b. Accordingly, the objects to be bonded 523 and 525 are heated in advance before being soldered, and the wettability of the solder ball with respect to the objects to be bonded 523 and 525 can be improved. As a result, a good finish is obtained by the soldering operation.

### (Soldering Apparatus)

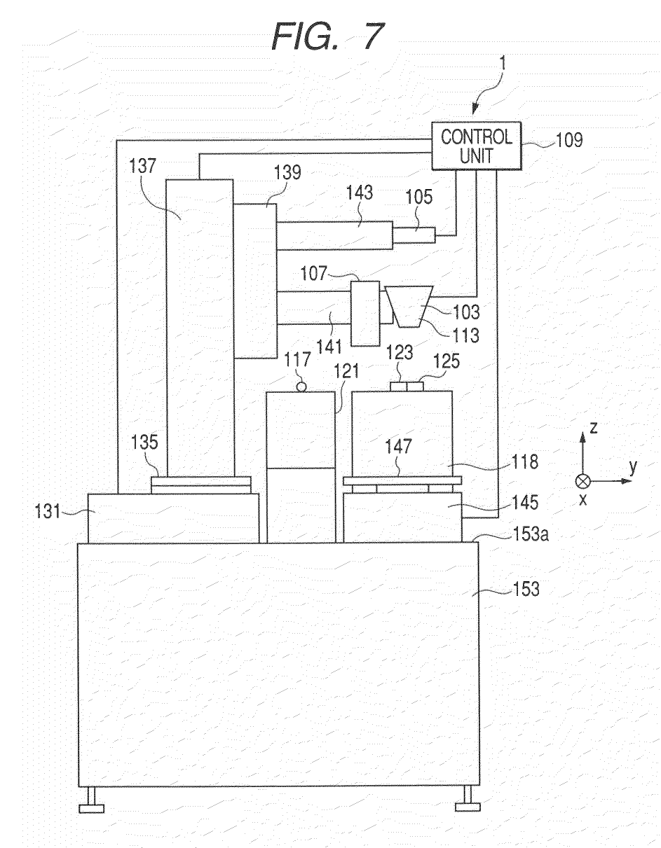

One example of the entire configuration of the soldering apparatus to which the bonding apparatus of the present invention is applied will be described. FIG. 7 is a side schematic view of a soldering apparatus 1. In the drawing, the x direction denotes the front-back direction of the drawing, the y direction denotes the lateral direction thereof, and the z direction denotes the vertical direction thereof.

The soldering apparatus 1 is an example in which the soldering apparatus of the embodiment 1 is incorporated. The soldering apparatus 1 mainly comprises a base 153, the nozzle 103 and the laser beam emit unit 105 which are mounted above a top face 153a of the base 153 in a movable manner in the y and z directions, the work bench 118 on which the objects to be bonded 123 and 125 are placed, the reservoir 121 on which the solder ball is placed, and the control unit 109 for actuating each component.

The soldering apparatus 1 further comprises a y-direction drive unit 131 for moving the nozzle 103 in the y and z directions, a y-direction slider 135 mounted on the y-direction drive unit 131 and moved in the y direction, a z-direction drive unit 137 fixed to the y-direction slider 135, and a z-direction slider 139 attached to the z-direction drive unit 137 and moved in the z direction.

A nozzle arm 141 and an emit unit arm 143 extending in the y direction are fixedly attached to the z-direction slider 139 in positions apart from each other in the z direction. The nozzle 103 and the laser beam emit unit 105 are respectively attached to the nozzle arm 141 and the emit unit arm 143.

Also, the work bench 118 is mounted on an x-direction slider 147 movable in the x direction by an x-direction drive unit 145. Accordingly, when the x-direction slider is moved by the x-direction drive unit 145, the work bench 118 can be moved in the x direction.

A well known configuration is used for the y-direction drive unit 131, the z-direction drive unit 137 and the x-direction drive unit 145. For example, the y-direction drive unit 131 can be constituted by a motor, a y ball screw, and a y nut, which are not shown. The y nut having a female screw is fixed to the y-direction slider 135. The y ball screw having a male screw provided on the periphery has the both ends supported by ball bearings in a rotatable manner in a housing of the y-direction drive unit. One of the ends of the y ball screw is coupled to the motor. When the motor is driven to rotate the y ball screw, the y-direction nut screwed with the y ball screw reciprocates along the y ball screw. By the reciprocation of the y-direction nut, the y-direction slider 135 is moved in the y direction. The other drive units can be similarly configured.

The reservoir 121 for storing the solder ball 117 is fixed to the top face 153a of the base 153 between the work bench 118 and the y-direction drive unit 131. The solder ball is carried to the reservoir 121 by unshown carrying means.

The control unit 109 is electrically connected to the y-direction drive unit 131, the z-direction drive unit 137, the x-direction drive unit 145, the laser beam emit unit 105 and the gas supply unit 107, and the respective units are actuated by a command from the control unit 109. Although not shown in the drawing, it is needless to say that a positioning camera, such as a CCD camera or the like, for performing positioning of the nozzle 103, the objects to be bonded 123 and 125, and the solder ball 117 in the reservoir 121 can be used to perform positioning control based on an image from the positioning camera.

In the soldering apparatus having the above configuration, the solder ball 117 is pressurized and fitted into the opening 113 of the nozzle 103 by operating the above x-direction drive unit, the y-direction drive unit and the z-direction drive unit in the x, y and z directions to bring the nozzle 103 into abutment with the solder ball 117. Accordingly, these drive units constitute the pressure and fit means.

The soldering operation using the above soldering apparatus 1 will be described. The y-direction drive unit 131 and the z-direction drive unit 137 receive a drive signal from the control unit 109, and move the nozzle 103 toward the reservoir 121. After the solder ball 117 is brought into abutment with the opening 113, the nozzle 103 is further lowered to pressurize and fit the solder ball 117 into the opening 113. After pressurizing and attaching the solder ball 117 to the opening 113, the nozzle 103 is moved to a boding position of the objects to be bonded 123 and 125 placed on the work bench 118. Positioning of the bonding position and the nozzle 103 is performed by operating the x-direction drive unit 145, the y-direction drive unit 131 and the z-direction drive unit 137.

The compressed gas is supplied into the inner space 111 (see FIG. 1B) of the nozzle 103 from the gas supply unit 107. When the inner space has a predetermined pressure, the laser beam emit unit 105 receives a drive signal from the control unit 109 and emits the laser beam to the solder ball 117 pressurized and attached to the opening 113. When the solder ball 117 is heated, the pressure-attachment to the opening 113 is released by the compressed gas from the gas supply unit 107, and the solder ball 117 lands on the bonding position. After the solder ball 117 lands on, the control unit 109 stops the gas supply unit 107. Also, since the projecting direction of the solder ball 117 and the traveling direction of the laser beam correspond to each other, the laser beam emit unit 105 continues to emit the laser beam until the entire solder ball 117 is melted. After the solder ball 117 is melted, the control unit 109 stops the laser beam emit unit 105. The molten solder is solidified and soldering of the objects to be bonded 123 and 125 is completed.

Although the laser beam continues to be emitted until after the solder ball is projected, moves away from the opening and lands on the bonding position in the above embodiments, it is needless to say that the entire solder ball may be melted before the solder ball reaches the bonding position.

Since the present invention is configured to project the solder ball in a solid phase state, the molten solder element does not adhere to the opening and the vicinity thereof by projecting the molten solder ball as in Japanese Patent Application Laid-Open No. 2002-25025. In the case of the configuration in which the molten solder element is projected, it is necessary to project the solder ball by setting the pressure in the inner space in consideration of the viscosity or the like of the solder element. However, according to the present invention, the pressure in the inner space can be set such that the solder ball is projected at a speed suitable for bonding, and the landing position accuracy of the solder element can be thereby improved.

Furthermore, a pressure value of the compressed gas suitable for causing the solder element to adhere to the objects to be bonded can be set. Accordingly, there is no adhesion failure of the solder element. Also, since the shutter for opening and closing the opening is not required, the influence of the shutter on the solder ball can be eliminated and the configuration of the soldering apparatus can be simplified.

### EXAMPLE

An example in which the soldering operation was performed by using the soldering apparatus of the embodiment 2 (see FIG. 4) will be described. An inner diameter D1 of the opening 313 of the nozzle 303 was 0.095 mm and a diameter D2 of the solder ball was 0.11 mm. The solder ball 317 was pressurized and attached to the opening 313 by the suction unit 325 with a suction pressure of −30.0 kPa, and the suction unit 325 was then stopped. The compressed gas was supplied from the gas supply unit 307 until the pressure in the inner space 311 reached 1.0 kPa. When the pressure in the inner space 311 reached 1.0 kPa, the laser beam emit unit 305 started to emit the laser beam to the solder ball 317.

As a comparative example, the soldering apparatus described in Japanese Patent Application Laid-Open No. 2006-305625 having the configuration in which the solder ball is held by the shutter was used. The inner diameter of the nozzle was 0.125±0.003 mm and the diameter D2 of the solder ball was 0.11 mm.

In the soldering apparatus in the present example and the comparative example, a nitrogen gas was used as the compressed gas. Also, a distance between the top end portion 313b of the nozzle and the landing position was 0.5 mm. A used laser was a YAG laser with a wavelength of 1064 nm and the spot diameter of the laser beam was φ200 μm at the landing position.

In the case of using the bonding apparatus according to the embodiment 2, the landing accuracy could be improved 25% to 30% in comparison with the bonding apparatus in the comparative example.

In the embodiments 1 to 3, the modifications and the example described above, heat is imparted to the solder ball, namely, the conductive element pressurized and attached to the opening to release the pressure-attachment. However, the present invention may be configured not only to reduce the frictional force by imparting the heat to the conductive element, but to release the pressure-attachment of the conductive element by using only the urging force by the compressed gas.

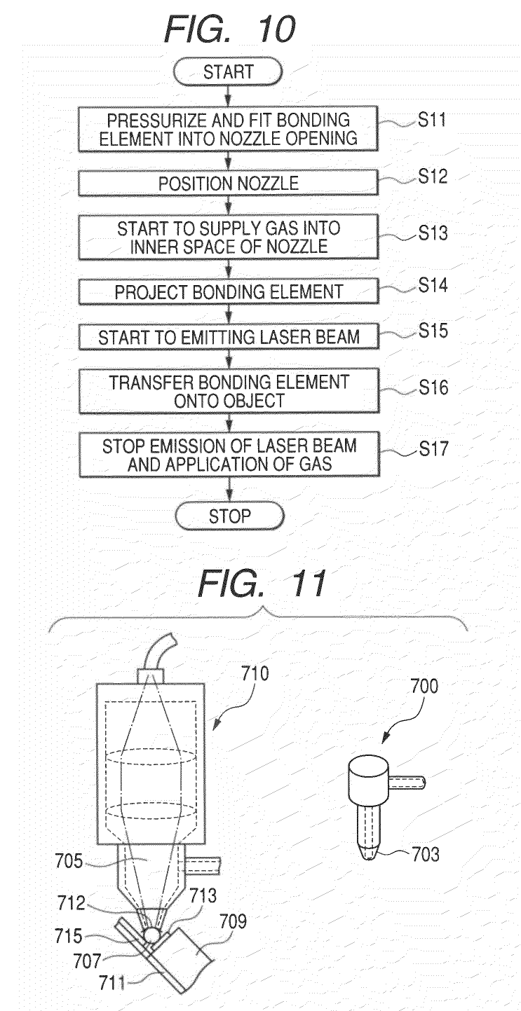

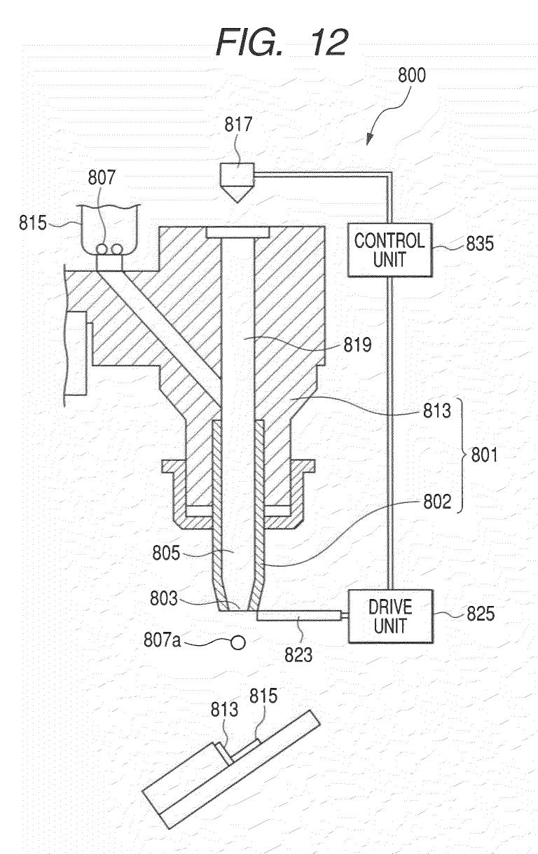

A method for projecting the solder ball by imparting an urging force P by the compressed gas, which is greater than the frictional force (μF1 shown in FIG. 1F), in order to release the pressure-attachment by using the soldering apparatus having the configuration shown in FIG. 1 can be cited as another example of the embodiment 1. FIG. 10 is a flowchart illustrating the soldering method for projecting the solder ball only by the compressed gas. As shown in the flowchart, the solder ball 117 is pressurized and attached to the opening 113 (the step S11, corresponding to FIG. 1A), and the nozzle 103 is positioned (the step S12). The gas supply unit 107 supplies the compressed gas into the inner space 111 (the step S13). When the urging force P against the solder ball 117 by the compressed gas is greater than the frictional force μF1 (corresponding to FIG. 1F), the solder ball 117 is projected in a solid phase state (the step S14). At this time, the laser beam is not emitted to the solder ball 117 unlike the embodiment 1. After that, the laser beam is emitted to the flying solder ball 117 (the step S15) to melt and cause the solder ball to land on a predetermined position. Subsequently, the emission of the laser beam and the supply of the compressed gas are stopped (the step S17), and the soldering process is terminated. As described above, the method of projecting the pressurized and attached solder ball without emitting the laser beam thereto may be also employed.

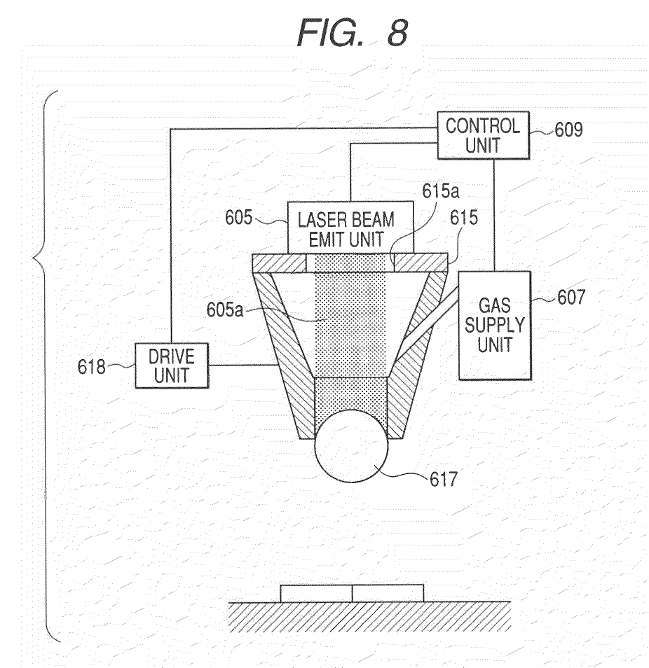

Furthermore, although the laser beam emit unit is formed separately from the nozzle, the nozzle and the laser beam emit unit may be integrally formed. FIG. 8 is a partial cross-sectional view of a soldering apparatus in which a laser beam emit unit 605 is fixed to a nozzle 603. The laser beam emit unit 605 is fixed to a top plate 615 of the nozzle 603. A laser beam 605a from the laser beam emit unit 605 enters an inner space 611 via a laser transmission unit 615a formed of glass or the like which is provided in the nozzle top plate 615, and reaches a solder ball 617. It is needless to say that, after the laser beam 605a from the laser beam emit unit reaches the solder ball 617 through the inner space 611 as described above and the solder ball 617 is projected, any change may be made as long as the projecting direction and the traveling direction of the laser beam can be aligned. The laser beam emit unit 605, a gas supply unit 607, a control unit 609, and a drive unit 618 have the same operations as the corresponding units described in the above embodiments, and therefore, the descriptions thereof are omitted here.

Although the laser beam emit unit is formed separately from the nozzle in the embodiments 1 to 3, the modifications and the example, the nozzle and the laser beam emit unit may be integrally formed. FIG. 8 is a partial cross-sectional view of a soldering apparatus in which a laser beam emit unit 605 is fixed to a nozzle 603. The laser beam emit unit 605 is fixed to a top plate 615 of the nozzle 603. A laser beam 605a from the laser beam emit unit 605 enters an inner space 611 via a laser transmission unit 615a formed of glass or the like which is provided in the nozzle top plate 615, and reaches a solder ball 617. It is needless to say that, after the laser beam 605a from the laser beam emit unit reaches the solder ball 617 through the inner space 611 as described above and the solder ball 617 is projected, any change may be made as long as the projecting direction and the traveling direction of the laser beam can be aligned.

Although the laser apparatus is used in the embodiments 1 to 3 and the modifications, the solder ball, namely, the solder element may be heated and melted by using halogen light or hot air. Also, the spherical solder ball is used as the solder element. However, it is needless to say that a solder element having a cube shape, a rectangular solid shape or the like may be used as needed.

In the embodiments 1 to 3, the modifications and the example, the solder ball is projected onto the objects to be bonded constituted by at least two members which are arranged in a planar shape, and the two members are bonded. However, the objects to be bonded of the present invention are not limited to the objects to be bonded arranged in a planar shape. For example, the objects to be bonded may be constituted by two members forming an angle of about 90 degrees with each other as an electrode of a substrate and a side electrode of an electronic component placed on the substrate shown in FIG. 10 or FIG. 11 referred to as the related background art.

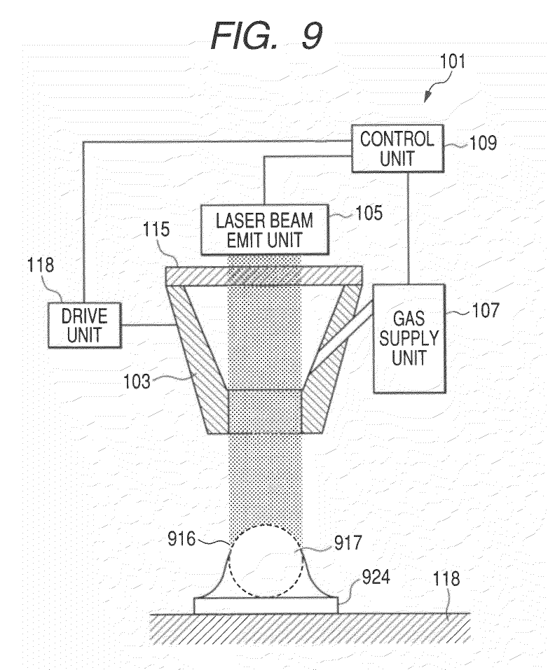

Also, a single member may be used as the object to be bonded. FIG. 9 illustrates the state in which the solder ball is projected onto the object to be bonded constituted by the single member and a solder bump is formed. In FIG. 9, the soldering apparatus 101 in FIG. 1 is used to cause a solder ball 917 to land on a flat-plate conductor 924 and form a solder bump 916.

In the embodiments 1 to 3, the modifications and the example, the conductive element pressurized and attached to the opening of the nozzle is located outside of the nozzle. However, it is needless to say that one portion of the conductive element may extend to the inside of the nozzle. For example, if the length of the opening in the longitudinal direction is relatively shorter than the outer diameter of the solder ball, one portion of the solder ball extends to the inside of the inner space.

Also, the optical axis of the laser beam, the central axis of the inner space, and the central axis of the opening correspond to each other in the same direction. However, as long as a laser beam can be scanned along the track of the solder ball projected from the opening, any laser apparatus may be used. It goes without saying that it is not necessary to align the optical axis of the laser beam and the projection route after the solder ball is projected.

From the perspective of prevention of oxidization of the solder ball, an inert gas (compressed gas) such as nitrogen or the like can be applied as the compressed gas in the above embodiments.

In the present invention, heat radiation is applied to the conductive element to release the pressure-attachment to the nozzle and start melting the conductive element. Therefore, the residue of the conductive element does not adhere to the nozzle opening and the vicinity thereof.

The present invention can be embodied in various forms without departing from the spirit thereof. Accordingly, it is needless to say that the above embodiments are only for describing the present invention, but not for limiting the scope of the present invention.

This application claims priority from Japanese Patent Application Nos. 2007-167258 filed on Jun. 26, 2007, and 2008-4358 filed on Jan. 11, 2008, which are hereby incorporated by reference herein in their entirety.

What is claimed is:

1. A bonding method for projecting a conductive element from a nozzle onto an object to be bonded and electrically bonding the object to be bonded and the conductive element, comprising the steps of:
preparing the conductive element having an outer diameter with a curvature radius larger than a curvature radius of a portion of an opening of the nozzle which is in contact with the conductive element;
pressurizing and attaching the conductive element to the opening of the nozzle; and
supplying a compressed gas into an inner space of the nozzle and projecting the conductive element in a solid phase state onto the object to be bonded.

2. A bonding method according to claim 1, further comprising the step of emitting heat radiation to the conductive element pressurized and attached to the opening when a pressure inside the inner space is at a predetermined value.

3. The bonding method according to claim 1, wherein the conductive element is pressurized and attached to the opening by pressing the nozzle against the conductive element.

4. The bonding method according to claim 1, wherein the conductive element is pressurized and attached to the opening by a suction force imparted to the opening via the inner space.

5. The bonding method according to claim 4, wherein the conductive element is pressurized and attached to the opening by pushing the conductive element in abutment with the opening by the suction force into the opening by a pressure and fit unit.

6. The bonding method according to claim 2, wherein, after the conductive element is projected, the heat radiation continues to be emitted to the conductive element.

7. A bonding apparatus for disposing a conductive element on an object to be bonded and electrically bonding the object to be bonded and the conductive element, comprising:
a nozzle having an opening with a curvature radius smaller than a curvature radius of an outer diameter of the conductive element, and an inner space in communication with an outside via the opening;
gas supply means for supplying a compressed gas into the inner space;
pressure and fit means for pressurizing and fitting the conductive element into the opening of the nozzle and pressurizing and attaching the conductive element to the opening; and
a control unit for controlling the gas supply means such that, with the conductive element being pressurized and attached to the opening, the compressed gas is supplied into the inner space and the conductive element is projected in a solid phase state.

8. The bonding apparatus according to claim 7, further comprising heat radiation emit means for emitting heat radiation to the conductive element pressurized and attached to the opening, wherein the control unit controls the heat radiation emit means such that the heat radiation is emitted to the conductive element when the inner space has the predetermined pressure.

9. The bonding apparatus according to claim 7, wherein the pressure and fit means pressurizes and fits the conductive element into the opening such that the conductive element is pressurized and attached with a portion of the conductive element having a larger dimension than an inner diameter of the opening being located outside of the nozzle.

10. The bonding apparatus according to claim 7, wherein the pressure and fit means has drive means for moving the opening and the conductive element in directions toward and away from each other.

11. The bonding apparatus according to claim 7, wherein the pressure and fit means has suction means for imparting a suction force to the opening via the inner space and assisting the pressure-attachment of the conductive element to the opening.
